(19) United States
(12) Patent Application Publication
(10) Pub. No.: US 2011/0027756 A1
(43) Pub. Date: Feb. 3, 2011

(54) ONE-PIECE INCLINED DENTAL IMPLANT

(76) Inventors: Jean Benatouil, Herzelia (IL); Eyal Milman, Tivoon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/937,541

(22) PCT Filed: May 21, 2009
(86) PCT No.: PCT/IB09/52141

§ 371 Date: Oct. 13, 2010

(30) Foreign Application Priority Data
May 21, 2008 (US) 61/054810

(51) Int. Cl. A61C 8/00

(52) U.S. Cl. 433/174

(57) ABSTRACT

A one-piece, inclined, dental-implant and corresponding method for the optimal exploitation of areas of relatively abundant bone structure as anchoring regions while preserving biological width and enhancing implant recovery.

### FIELD AND BACKGROUND OF THE INVENTION

The present invention relates to dental implants and, in particular, it concerns a one-piece, inclined dental-implant configured for the optimal exploitation of areas having relatively abundant bone structure as anchoring regions

Common treatment methods of edentulous, atrophic bone patients require either complicated bone augmentation procedures to construct an anchoring structure for dental implants or insertion of dental implants at angles non-perpendicular to the crestal surface of alveolar process to exploit those areas having relatively more ample supply of bone tissue. These angles of inclination cause the abutment surface to be orientated in positions unsuitable for use with prosthetics or bridges. Generally, additional hardware is attached to the implant to provide a properly orientated abutment surface useful for the attachment of dental prosthetics and bridges.

However, such arrangements suffer from inevitable microbial colonization along the line of connection between the abutment head and the implant shaft thereby resulting in loss of biological width and consequent bone resorption.

A second draw back of the above-described, two-piece implants relates to inclined implantation limitations for which the abutment heads are able to correct. The connection arrangement used to attach the abutment correction hardware to the shaft limits abutment surface angles of inclination (relative to the longitudinal axis of the implant) to less than thirty degrees, thereby limiting the deployment of the implants specifically to areas requiring a corresponding implant inclination.

U.S. Pat. No. 5,362,236 discloses an angular, dental implant configured to be anchored in the maxilla the zygomatic process. The shortcoming with this implant is that its exceedingly long shaft makes it limited to use in the maxilla and zygomatic process.

There is, therefore, a need for a dental-implant configured to exploit those areas of the mandible or the maxillae having sufficient anchoring structure while preserving the biological width.

### SUMMARY OF THE INVENTION

The present invention is a one-piece, inclined dental-implant and corresponding method for exploiting areas of relatively abundant bone structure as anchoring regions while preserving biological width and enhancing implant recovery.

According to the teachings of the present invention there is provided, a method for inclined implantation of one-piece dental implants into a crestal surface of an alveolar process of a patient comprising: (a) drilling a bore into the crestal surface of the alveolar process at a angle non-perpendicular to the crestal surface, (b) inserting the dental implant into said bore, the dental implant having: i. a threaded shaft not exceeding twenty-two millimeters in length, and ii. an abutment surface on top of an abutment head integrally formed with said shaft, said abutment surface being disposed so as to form an angle with said shaft so that when said shaft is implanted in an inclined position within the alveolar process, said abutment surface is disposed in a substantially parallel position relative to the crestal surface, suitable for attachment of a dental prosthetic or an arch bridge, and (c) rotating said implant until said implant advances into a final, implant position in which said abutment head is disposed in a position substantially parallel to the crestal surface of the alveolar process, suitable for the attachment of a dental prosthetic or an arch bridge.

According to a further feature of the present invention the shaft is implemented as a first shaft-section integrally formed with a second-shaft section, said second shaft-section having a diameter and said first shaft-section having a diameter changing as a function of increasing distance from said abutment head such that the diameter of said first shaft-section progressively decreases and then progressively increases to the diameter of said second shaft-section.

According to a further feature of the present invention the second shaft-section is implanted as a tapered shaft decreasing in diameter as a function of increasing distance from said first shaft section.

According to a further feature of the present invention the abutment head is implemented with a lateral surface geometry having at least one engagement surface for being engaged by an insertion tool having corresponding inner socket geometry.

There is also provided according to the teaching of the present invention a one-piece dental-implant for implantation non-perpendicular to a crestal surface of an alveolar process of a patient comprising: a threaded shaft not exceeding twenty-two millimeters in length, and (b) an abutment surface on top of an abutment head integrally formed with said shaft, said abutment surface being disposed so as to form an angle with said shaft so that when said shaft is implanted in an inclined position within the alveolar process, said abutment surface is disposed in a substantially parallel position relative to the crestal surface of the alveolar process, suitable for attachment of a dental prosthetic or an arch bridge.

According to a further feature of the present invention the shaft is implemented as a first shaft-section integrally formed with a second shaft-section, said second shaft-section having a diameter and said first shaft-section having a diameter changing as a function of increasing distance from said abutment head such that the diameter of said first shaft-section progressively decreases and then progressively increases to the diameter of said second shaft-section.

According to a further feature of the present invention the second shaft-section is implanted as a tapered shaft decreasing in diameter as a function of increasing distance from said first shaft section.

According to a further feature of the present invention the abutment head is implemented with a lateral surface geometry having at least one engagement surface for being engaged by an insertion tool having corresponding inner socket geometry.

### BRIEF DESCRIPTION OF THE DRAWINGS

The invention is herein described, by way of example only, with reference to the accompanying drawings, wherein:

FIG. 1 is an isometric view of the dental-implant depicting the inclined abutment surface and reduced diameter portion of the shaft.

FIG. 2 is schematic side view of the dental-implant of FIG. 1:

FIG. 3 is a schematic, partial cross-sectional side view of the dental-implant of FIG. 1.

FIGS. 4 and 5 are isometric views of the dental-implant depicting the inclined abutment surface and an engagement arrangement.

FIGS. 6 and 7 are schematic cross-sectional views of the dental implants implanted in alveolar processes of lower and upper jawbones, respectively.

### DESCRIPTION OF THE PREFERRED EMBODIMENTS

The present invention is a one-piece, inclined dental-implant and a corresponding method for exploiting areas of relatively abundant bone structure as anchoring regions while preserving biological width and enhancing implant recovery. The principles, methods and operation according to the present invention may be better understood with reference to the drawings and the accompanying description. It should be noted that the term “alveolar process” appearing throughout this document refers to the process found on the mandible and the maxillae.

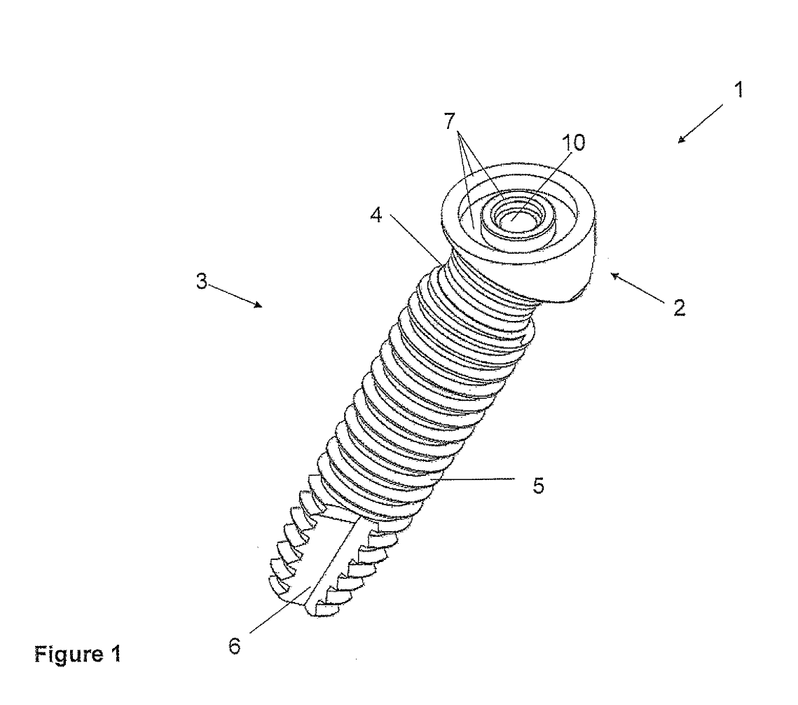

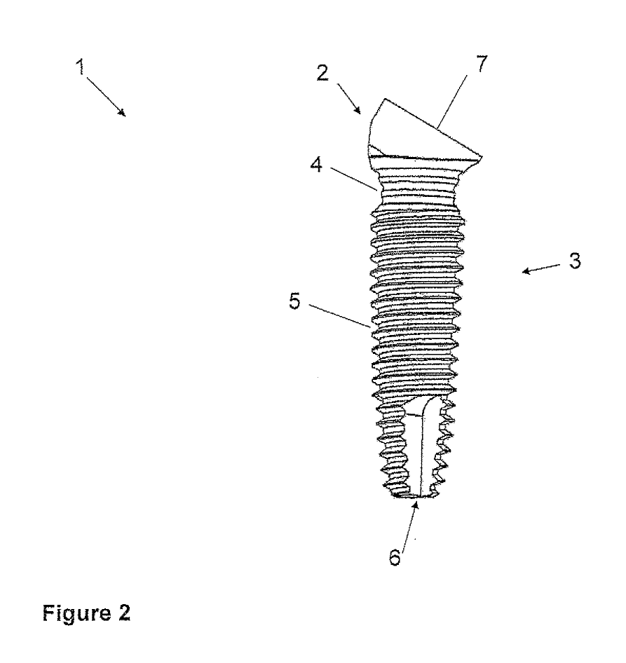

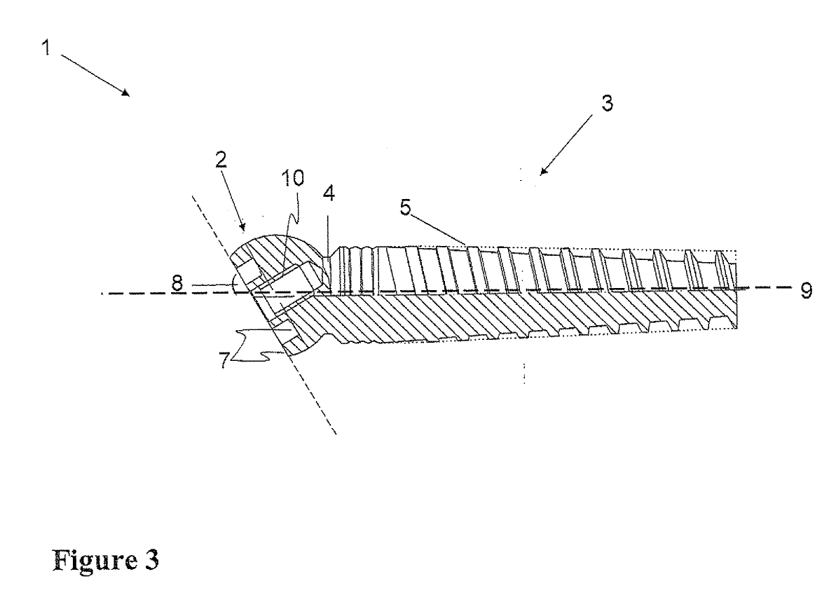

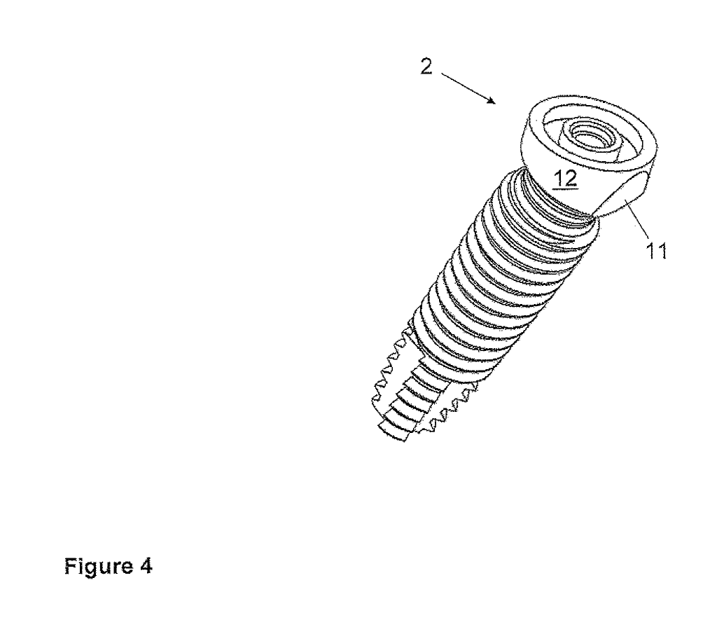

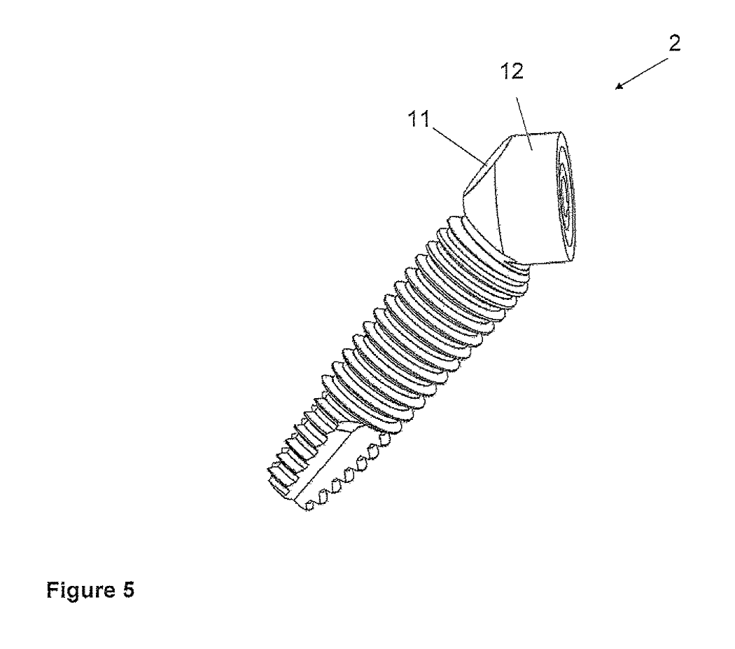

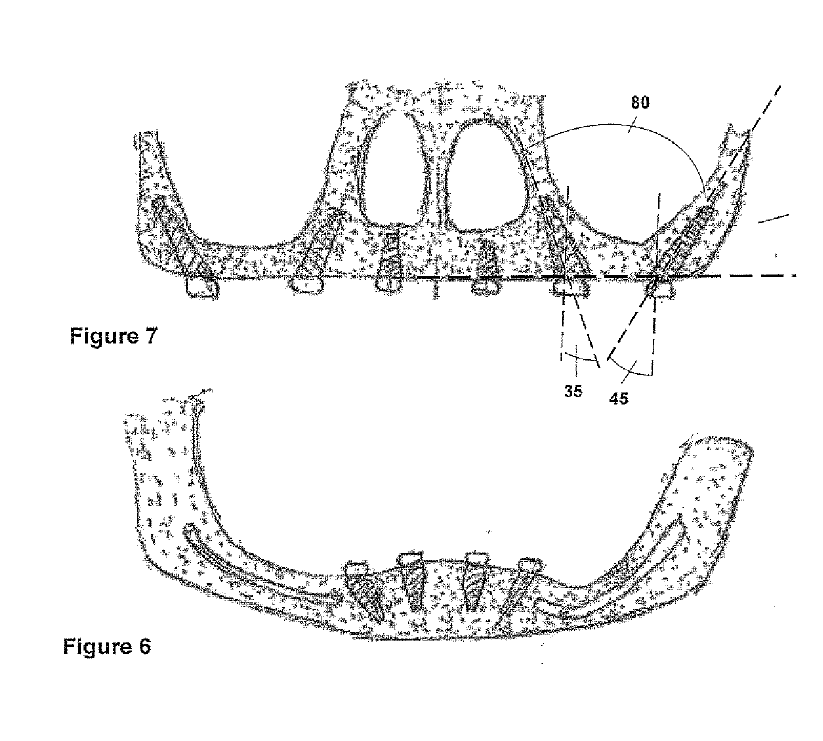

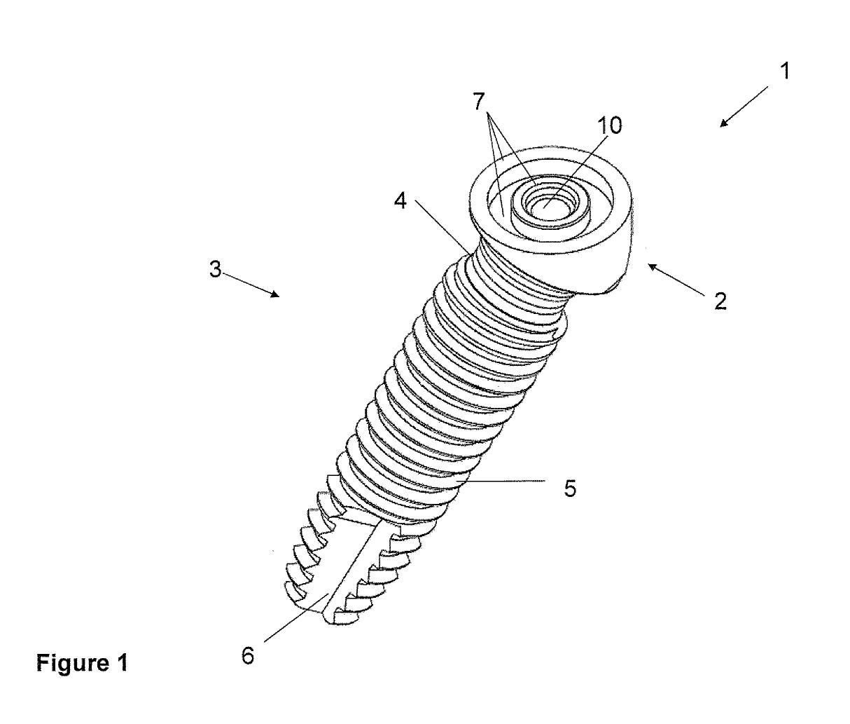

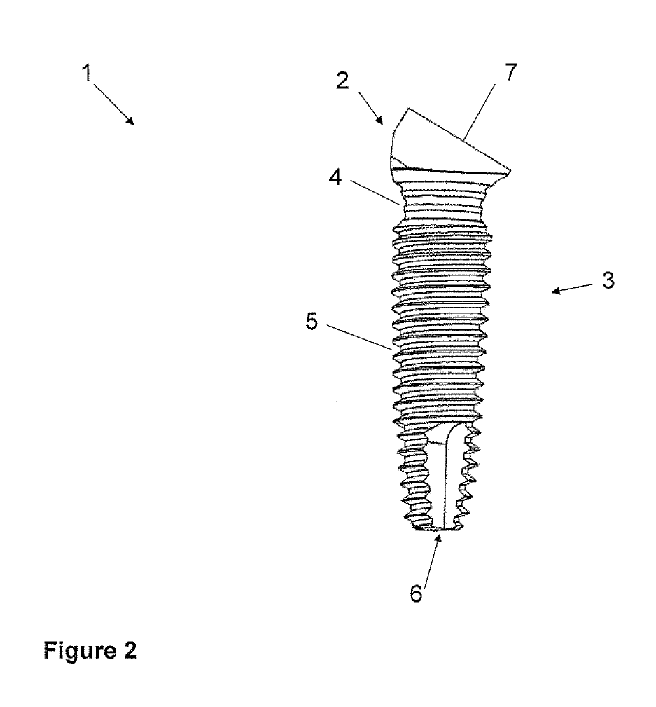

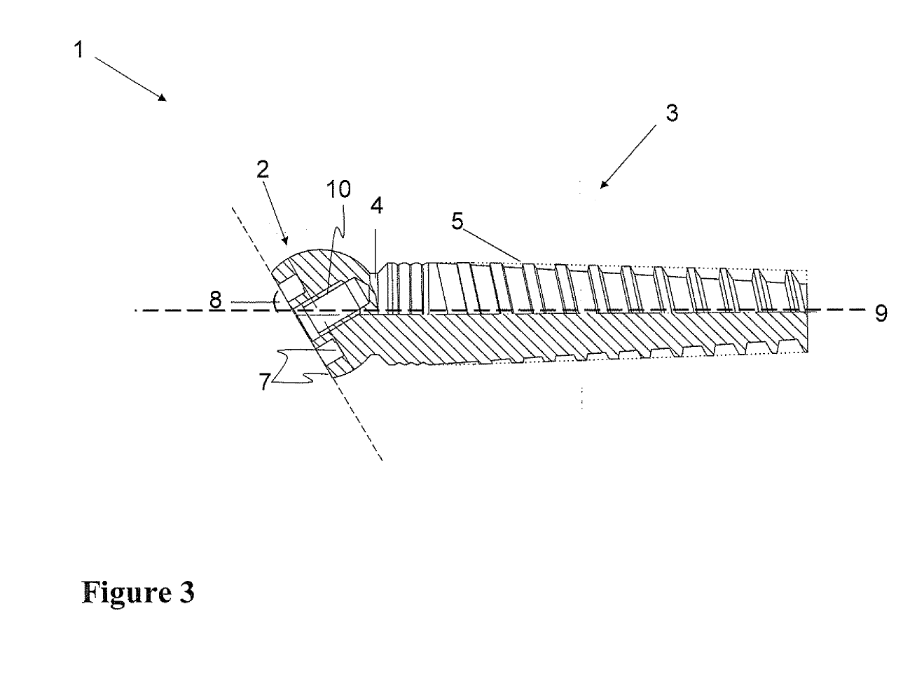

FIGS. 1 and 2 depict a one-piece dental-implant designated generally 1, which includes abutment head 2, and threaded shaft 3. Threaded shaft 3 includes a first shaft-section 4, a second shaft-section 5 and self-tapping recess 6. Abutment head 1 includes abutment surfaces 7, and threaded connection arrangement 10. Abutment surface 7 is a surface or a collection of surfaces disposed on the uppermost portion of abutment head 2 and provides the supporting structure for attached dental prosthetics or bridges structures as will be discussed later in this document. For the purposes of convenience, the present document refers to the totality of annular abutment surfaces disposed at different heights in the non-limiting, preferred embodiment disclosed herewith as an “abutment surface”. It should be noted however that any abutment surface 7 disposed on abutment head 2 in a manner so as to form a non-perpendicular angle with longitudinal shaft axis 9, as is most clearly visible in FIG. 3, is included within the scope of the current invention. As mentioned above, implant 1 is configured to be anchored in an area of the alveolar process having a sufficient anchoring structure adjacent to a region of inadequate anchoring structure in vertical alignment with the point of implant insertion. The prosthetic or bridge structure requires abutment surface 7 to be disposed substantially parallel with the crestal surface of alveolar process. The abutment surface angle-of-inclination, as shown in FIG. 3 designation 8, serves as a built-in, corrective feature for devices implanted at angles non-perpendicular to the crestal surface of the alveolar process. Implant 1 is constructed in accordance to the needs of the patient, so that angle-of-inclination of abutment surface 7 matches the prescribed implant inclination; consequently implantation abutment surface 7 is disposed substantially parallel with the crestal surface of alveolar process. A dental prosthetic attached to such an abutment will then be in alignment with the natural dentition without the use of additional correction hardware. Furthermore, the absence of correction hardware enables the implants to be constructed with relatively large abutment surface angles thereby enabling corresponding large implantation inclinations; i.e. exceeding 45 degrees. Consequently, the implants may be employed in a large range of locations according to the patient's needs. It should be noted that in certain non-limiting, exemplary embodiments, abutment surface 7 is disposed on the abutment head 2 so as to form an angle of inclination 8 with longitudinal axis 9 of 17 degrees, 30 degrees, and in certain cases, 45 degrees. It should be noted; however, that angles of inclination 8 ranging from one to ninety degrees relative to longitudinal axis 9 are within the scope of the current invention. Furthermore, angle of inclinations 8 advantageously enables the usage of bridge structures to be attached to a plurality of implants 1 having a total implant inclination between two adjacent implants ranging from 0-180 degrees; FIG. 7 depicts implants 1 whose collective implant inclination is 80 degrees.

Threaded attachment arrangement 10 is implemented in a non-limiting, preferred arrangement as a bore disposed in the center of abutment head 2 as shown in FIGS. 1, 3 and 4. It should be appreciated that a bored frustum structure or any other single screw connection arrangement for dental prosthetics or bridges are within the scope of the current invention.

Abutment head 2 is integrally formed with shaft 3, and more specifically with first shaft-section 4. This integral connection between the abutment head and first shaft-section 4 advantageously eliminates surface irregularities characteristic of joints that inevitably serve as a haven for microbial colonization leading to biological width reduction and eventual bone resorption as mentioned above. The single piece construction advantageously adds strength to dental implant 1 and simplifies procedures involved in implantation by eliminating the need to connect additional hardware used to provide a useful abutment surface for the connection of dental prosthetics and bridges. First shaft-section 4 is implemented in a non-limiting, preferred embodiment as a progressively changing diameter as a function of increasing distance from abutment head 2 such that the diameter of the first shaft-section is at a maximum at the juncture point with abutment head 2, progressively decreases and then progressively increases until it reaches its maximum diameter at the juncture point with the second shaft-section 5 as shown in FIGS. 1 and 2. This shaft configuration advantageously facilities blood flow and regeneration of connective tissue thereby enhancing recovery after implant surgery. It should be appreciate that any shaft configuration a progressively increasing a progressively decreasing diameter is within the scope of the current invention. providing the In a non-limiting, preferred embodiment, second shaft-section 5 is implemented as a tapered shaft narrowing in diameter as a function of increasing distance from first shaft-section 4 and includes self tapping recess 6 disposed in the distal end of second shaft-section 5 to facilitate self-tapping as implant 1 advances through a bore drilled into the patient's alveolar process. In a non-limiting, exemplary embodiment, the degree of taper ranges from one to three degrees. It should be noted that a second shaft-section having a constant diameter throughout its length is also included within the scope of the current invention. In a non-limiting, preferred embodiment first shaft-section 4 ranges in diameter from 2.0-5.0 millimeters (including threading heights) at the widest diameter whereas the widest diameter of the shaft 3 ranges between 2.5-6.0 millimeters

FIGS. 4 and 5 depict an additional feature relating to the insertion and removal of implant 1 from the upper and lower jawbones by way of an insertion tool (not-shown). Abutment head 2 has a lateral surface geometry including curved surface 12 and a planar surface 11 that collectively form a an engagement structure suited for receiving a torque applied by an insertion tool having a socket with a corresponding, inner-surface geometry. Lateral insertion configurations advantageously eliminate the danger of deforming abutment surface 7 or connection arrangements 10 disposed within the boundaries of abutment head 2 when applying a torque during insertion or removal of implant 1. It should be noted that any combination of lateral surface geometries configured to be engaged by a torque directing device is within the scope of the current invention.

In a preferred, unlimited embodiment, the implants are constructed from titanium or any other material having the bin-compatibility and strength associated with titanium. Furthermore, it should be noted that single, double, or multiple threading are included in the scope of the current invention. Thread and taper dimensions are those employed by practitioners skilled in the art. In a non-limiting, preferred embodiment, the length of entire implant 1, from the uppermost portion of abutment head 2 to the distal portion of shaft 3 does not exceed twenty millimeters, of which shaft 3 is about 15 millimeters.

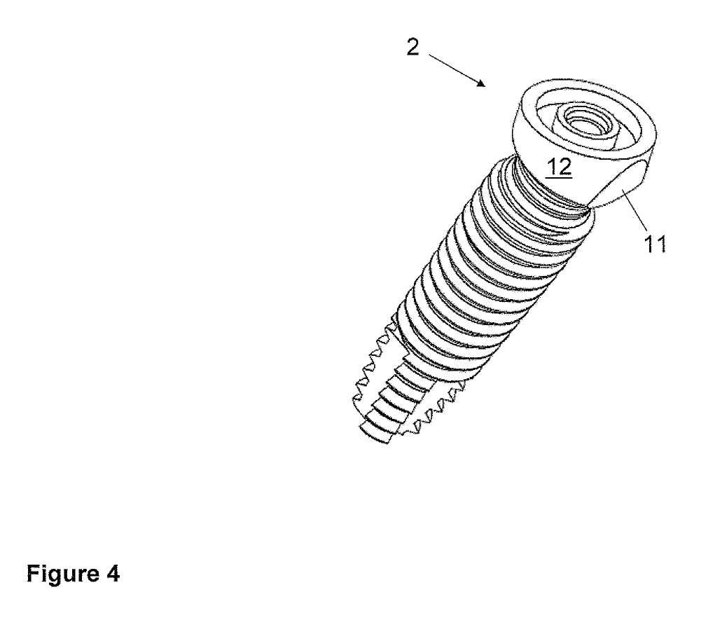

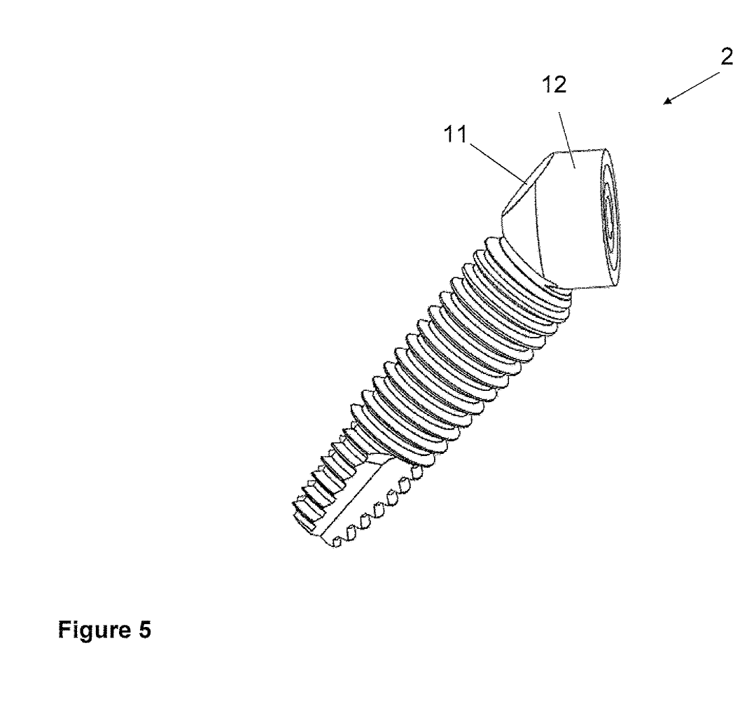

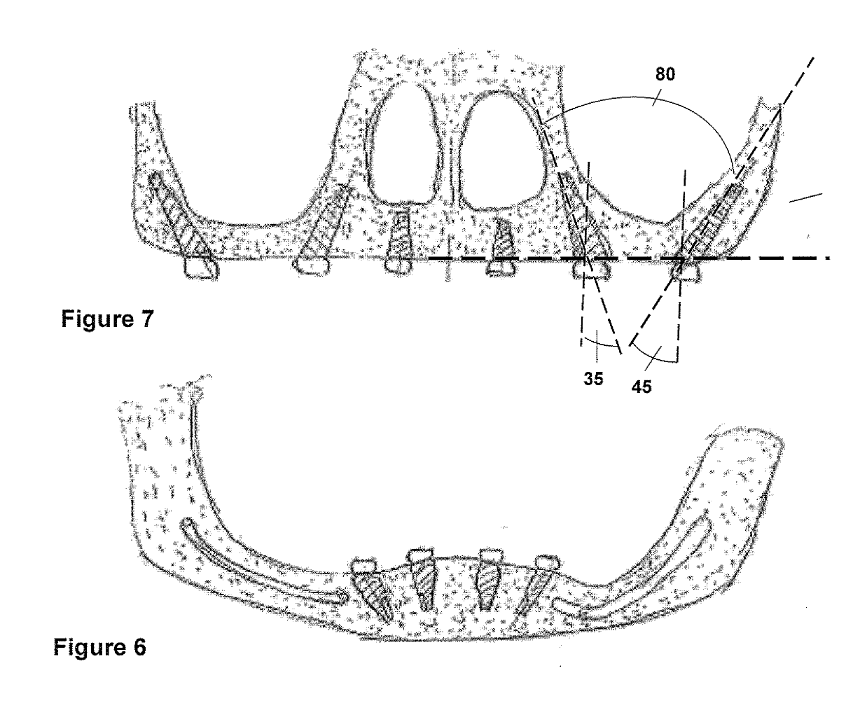

Dental implant 1 is implanted by drilling a bore of a diameter appropriate for the implant of choice into the alveolar process at an angle of inclination leading into a region of relatively abundant bone structure as shown in FIGS. 6 and 7. The self-tapping shaft 3 advances through the bore as implant 1 is rotated by way of the insertion tool (not shown) until implant 1 is disposed in the desired anchoring regions where it is held firmly in place. As mentioned above, when implant 1 is positioned in its final implant position, abutment surface 7 is disposed in a position substantially parallel to the crestal surface of the alveolar process in preparation of connection of a dental prosthetic or bridge structure.

It will be appreciated that the above descriptions are intended only to serve as examples, and that many other embodiments are possible within the scope of the present invention as defined in the appended claims.

1-8. (canceled)

9. An angular, single-piece dental implant for enhanced recovery from dental-implant surgery comprising:
(a) an implant shaft having a first shaft-section integrally connected to a second shaft-section;
(b) an abutment head integrally connected with first shaft-section, said abutment head having at least one abutment surface defining a plane non-perpendicular to a longitudinal, central-axis of said implant,
wherein said first shaft-section has a shaft configuration in which a shaft diameter progressively decreases as a function of distance from said abutment head to a minimum first shaft-section diameter and then progressively increases to a second shaft-section diameter, thereby enhancing blood flow and regeneration of connective tissue when the dental implant is implanted.

10. The single-piece dental implant of claim 9, wherein said abutment head includes at least one threaded attachment arrangement for connection of dental prosthetics and bridges to said abutment head.

11. The single-piece dental implant of claim 9, wherein said abutment head includes at least one engagement surface disposed on an outer surface of said abutment head for receiving a torque applied by an insertion tool having corresponding engagement geometry.

12. The single-piece dental implant of claim 9, wherein said second shaft-section includes a tapered shaft having a shaft diameter progressively decreasing as a function of distance from said first shaft-section.

13. A method for enhancing recovery from dental-implant surgery comprising:
(a) inserting a single-piece, dental implant into a bore drilled into a crestal surface of an alveolar process, said dental implant having:
i. an implant shaft having a first shaft-section integrally connected to a second shaft-section;
ii. an abutment head integrally connected with said first shaft-section, said first shaft-section being configured such that a shaft diameter progressively decreases as a function of distance from said abutment head to a minimum first shaft-section diameter and then progressively increases to a second shaft-section diameter
(b) rotating said implant until said implant advances into a final, implant position in which said first shaft-section is disposed the alveolar process, thereby enhancing blood flow and regeneration of connective tissue.
alveolar process, thereby enhancing blood flow and regeneration of connective tissue.

14. The method of claim 13, wherein said abutment head further comprising at least one abutment surface defining a plane non-perpendicular to a longitudinal, central-axis of said implant.

15. The method of claim 13, wherein said abutment head includes at least one threaded attachment arrangement for connection of dental prosthetics or bridges to said abutment head.

16. The method of claim 13, wherein said abutment head includes at least one engagement surface disposed on an outer surface of said abutment head for receiving a torque applied by an insertion tool having corresponding engagement geometry.

17. The method of claim 13, wherein said second shaft-section includes a tapered shaft having a shaft diameter progressively decreasing as a function of distance from said first shaft-section.
